(19) United States
(12) Patent Application Publication
(10) Pub. No.: US 2024/0220384 A1
(43) Pub. Date: Jul. 4, 2024

(54) INFORMATION DISPLAY METHOD, APPARATUS, DEVICE AND STORAGE MEDIUM

(71) Applicant: Beijing Bytedance Network Technology Co., Ltd., Beijing (CN)

(72) Inventors: Mingkun XIA, Beijing (CN); Kai LI, Beijing (CN); Rui YUAN, Beijing (CN); Ke CHEN, Beijing (CN)

(21) Appl. No.: 18/547,537

(22) PCT Filed: Mar. 3, 2022
(86) PCT No.: PCT/CN2022/079115

§ 371 Date: Aug. 23, 2023

(30) Foreign Application Priority Data
Apr. 25, 2021 (CN) 202110448774.0

(51) Int. Cl. G06F 11/30

(52) U.S. Cl. CPC G06F 11/3058; G06F 11/3093

(57) ABSTRACT

Embodiments of the present disclosure provide an information display method, an apparatus, a device and a storage medium, in which a platform list is firstly displayed in an interface of a terminal device; then an operation and maintenance page of a first platform is displayed on the interface of the terminal device in response to a selection operation of a user on a platform identifier of the first platform, where the operation and maintenance page includes at least one of a stream-pushing page, a controlling page and a monitoring page.

### CROSS-REFERENCE TO RELATED APPLICATION

This application is a National Stage of International Application No. PCT/CN2022/079115, filed on Mar. 3, 2022, which claims priority to Chinese Patent Application No. 202110448774.0, filed with the China National Intellectual Property Administration on Apr. 25, 2021 and entitled “INFORMATION DISPLAY METHOD, APPARATUS, DEVICE AND STORAGE MEDIUM”. The disclosures of the aforementioned two applications are hereby incorporated by reference in their entireties.

### TECHNICAL FIELD

Embodiments of the present disclosure relate to the field of computer and network communication and, in particular, to an information display method, an apparatus, a device, and a storage medium.

### BACKGROUND

With the continuous development of science and technology, users have higher and higher requirements for the experience of various applications. From the installation location, applications can include local applications and cloud applications. Cloud applications are widely used because they can reduce the hardware cost of the users and avoid the time-consuming problem of installing large-scale applications locally. In related technologies, cloud applications usually need to be installed on a server instance, allowing the users to run cloud applications through the server instance.

However, the inventor found that there are at least the following technical problems when running the cloud application through the server instance: the user is unable to monitor the operation of the server instance accordingly, resulting in poor cloud application experience of the user.

### SUMMARY

Embodiments of the present disclosure provide an information display method, an apparatus, a device, and a storage medium, so as to overcome the problem that a user is unable to monitor operation of a server instance accordingly, resulting in poor cloud application experience of the user.

In a first aspect, an embodiment of the present disclosure provides an information display method, including:
displaying a platform list in an interface of a terminal device, where the platform list includes a platform identifier corresponding to at least one platform; and
displaying an operation and maintenance page of a first platform on the interface of the terminal device in response to a selection operation of a user on the platform identifier of the first platform, where the operation and maintenance page includes at least one of a stream-pushing page, a controlling page and a monitoring page.

In a second aspect, an embodiment of the present disclosure provides an information display method, including:
sending a platform list to a terminal device, where the platform list includes a platform identifier corresponding to at least one platform;
receiving an acquisition request for an operation and maintenance page of a first platform sent by the terminal device; and
acquiring the operation and maintenance page corresponding to the first platform according to the acquisition request for the operation and maintenance page, and sending the operation and maintenance page corresponding to the first platform to the terminal device, where the operation and maintenance page includes at least one of a stream-pushing page, a controlling page and a monitoring page.

In a third aspect, an embodiment of the present disclosure provides an information display apparatus, including:
a displaying module, configured to display a platform list in an interface of a terminal device, where the platform list includes a platform identifier corresponding to at least one platform;
a processing module, configured to control the displaying module to display an operation and maintenance page of a first platform on the interface of the terminal device in response to a selection operation of a user on the platform identifier of the first platform, where the operation and maintenance page includes at least one of a stream-pushing page, a controlling page and a monitoring page.

In a fourth aspect, an embodiment of the present disclosure provides an information display apparatus, including:
a sending module, configured to send a platform list to a terminal device, where the platform list includes a platform identifier corresponding to at least one platform;
a receiving module, configured to receive an acquisition request for an operation and maintenance page of a first platform sent by the terminal device;
a processing module, configured to acquire the operation and maintenance page corresponding to the first platform according to the acquisition request for the operation and maintenance page, and send the operation and maintenance page corresponding to the first platform to the terminal device through the sending module, where the operation and maintenance page includes at least one of a stream-pushing page, a controlling page and a monitoring page.

In a fifth aspect, an embodiment of the present disclosure provides an electronic device, including:
at least one processor and a memory;
where the memory has a computer-executable instruction stored therein;
the at least one processor executes the computer-executed instruction stored in the memory to enable the at least one processor to perform the information display method according to the first aspect or the second aspect.

In a sixth aspect, an embodiment of the present disclosure provides a computer-readable storage medium in which a computer-executable instruction is stored, where when the computer-executable instruction is executed by a processor, the information display method according to the first aspect or the second aspect is implemented.

In a seventh aspect, an embodiment of the present disclosure provides a computer program product including a computer program, which, when being executed by a processor, implements the information display method according to the first aspect or the second aspect.

In an eighth aspect, an embodiment of the present disclosure provides a computer program, which, when being executed by a processor, implements the information display method according to the first aspect or the second aspect.

The present embodiments provide an information display method, an apparatus, a device and a storage medium, which firstly displays a platform list in an interface of a terminal device, where the platform list includes a platform identifier corresponding to at least one platform; then displays an operation and maintenance page of a first platform on the interface of the terminal device in response to a selection operation of a user on the platform identifier of the first platform, where the operation and maintenance page includes at least one of a stream-pushing page, a controlling page and a monitoring page. The embodiments of the present disclosure can display the operation and maintenance page of the first platform in the display page of the terminal device in real time, so that the operation and maintenance information of the first platform can be monitored in real time through the operation and maintenance page, and the user's application experience of the first platform can be further enhanced.

### BRIEF DESCRIPTION OF DRAWINGS

In order to explain the technical solutions in the embodiments of the present disclosure or the prior art more clearly, the following will briefly introduce the drawings to be used in the description of the embodiments or the prior art. Obviously, the drawings in the following description are intended for some embodiments of the present disclosure, and for those of ordinary skilled in the field, other drawings can be obtained based on these drawings without any creative effort.

FIG. 1 is a schematic diagram of an application scenario of an information display provided by an embodiment of the present disclosure.

FIG. 2 is a flowchart of an information display method provided by an embodiment of the present disclosure.

FIG. 3 is a schematic diagram of information display provided by an embodiment of the present disclosure.

FIG. 4 is a first signaling interaction diagram of an information display method provided by an embodiment of the present disclosure.

FIG. 5 is an information display schematic diagram of a controlling page provided by an embodiment of the present disclosure.

FIG. 6 is a first information display schematic diagram of a stream-pushing page provided by an embodiment of the present disclosure.

FIG. 7 is a second signaling interaction diagram of an information display method provided by an embodiment of the present disclosure.

FIG. 8 is a second information display schematic diagram of a stream-pushing page provided by an embodiment of the present disclosure.

FIG. 9 is a third information display schematic diagram of a stream-pushing page provided by an embodiment of the present disclosure.

FIG. 10 is a third signaling interaction diagram of an information display method provided by an embodiment of the present disclosure.

FIG. 11 is an information display schematic diagram of a configuration page provided by an embodiment of the present disclosure.

FIG. 12 is a fourth signaling interaction diagram of an information display method provided by an embodiment of the present disclosure.

FIG. 13 is a first information display schematic diagram of an application program management page provided by an embodiment of the present disclosure.

FIG. 14 is a second information display schematic diagram of an application program management page provided by an embodiment of the present disclosure.

FIG. 15 is a fifth signaling interaction diagram of an information display method provided by an embodiment of the present disclosure.

FIG. 16 is a first schematic diagram of an information display apparatus provided by an embodiment of the present disclosure.

FIG. 17 is a second schematic diagram of an information display apparatus provided by an embodiment of the present disclosure.

FIG. 18 is a schematic diagram of an electronic device provided by an embodiment of the present disclosure.

### DESCRIPTION OF EMBODIMENTS

In order to describe objectives, technical solutions, and advantages of embodiments of the present disclosure more clearly, the technical solutions in the embodiments of the present disclosure will be described hereunder clearly and comprehensively with reference to the accompanying drawings in the embodiments of the present disclosure. Apparently, the described embodiments are only a part of embodiments of the present disclosure, rather than all embodiments of the present disclosure. All other embodiments obtained by those of ordinary skilled in the field based on the embodiments of the present disclosure without any creative effort shall fall into the protection scope of the present disclosure.

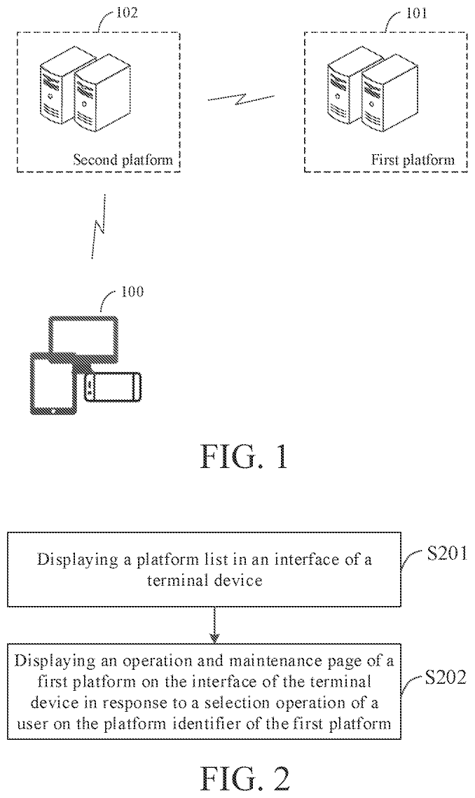

For the convenience of understanding, firstly, an application scenario of an embodiment of the present disclosure will be described with reference to FIG. 1.

FIG. 1 is a schematic diagram of an application scenario of an information display provided by an embodiment of the present disclosure. Referring to FIG. 1, the scenario includes a terminal device 100, a first platform 101 and a second platform 102.

The first platform 101 may be an instance of a cloud server, and the specific type of the first platform 101 is not specifically limited in the embodiment of the present disclosure. In practical application, an application program is installed on the first platform 101, and a user can run a cloud applications through the first platform 101. However, at present, when using the first platform 101, it is impossible to monitor the operation of the first platform 101, which leads to poor cloud application experience for users.

In view of the above, embodiments of the present disclosure provide an information display method, an apparatus, a device and a storage medium to enable the management and monitoring of the first platform 101 through the second platform 102.

In one implementation, a management page of the second platform 102 is displayed on an interface of the terminal device 100 by running the second platform 102 on the terminal device 100, so that a corresponding function of the second platform 100 is triggered on the management page of the second platform 102 by the terminal device 100, and a visual management of the first platform 101 is further realized. It should be understood that each second platform 102 can be used to manage multiple first platforms 101 of users (one is shown as an example in the figure, but not limited thereto).

Specifically, the interface of the terminal device 100 displays a platform list containing multiple first platforms 101. When the user selects a certain first platform 101 from the platform list, an operation and maintenance page of the first platform 101 will be displayed in the interface of the terminal device 100, so that the user can monitor the operation condition of the first platform 101 in real time through the operation and maintenance page, thereby enhancing the user's application experience.

It should be noted that the type of the second platform 102 is not specifically limited in the embodiments of the present disclosure. For example, it can be any one of the following: a Platform as a Service (abbreviated as PaaS) platform, a Software as a Service (abbreviated as SaaS) platform, an Infrastructure as a Service (abbreviated as IaaS) platform or a Backend as a Service (abbreviated as BaaS) platform and the like.

The technical solution of the embodiments of the present disclosure and how the technical solution of the present disclosure can solve the above technical problems will be described in detail with specific examples. The following specific embodiments can be combined with each other, and the same or similar concepts or processes may not be repeated in some embodiments. Hereinafter, the embodiments of the present disclosure will be described with reference to the accompanying drawings.

FIG. 2 is a flowchart of an information display method provided by an embodiment of the present disclosure. Referring to FIG. 2, the information display method of the present embodiment includes the following steps.

S201, displaying a platform list in an interface of a terminal device, where the platform list includes a platform identifier corresponding to at least one platform.

S202, displaying an operation and maintenance page of a first platform on the interface of the terminal device in response to a selection operation of a user on the platform identifier of the first platform.

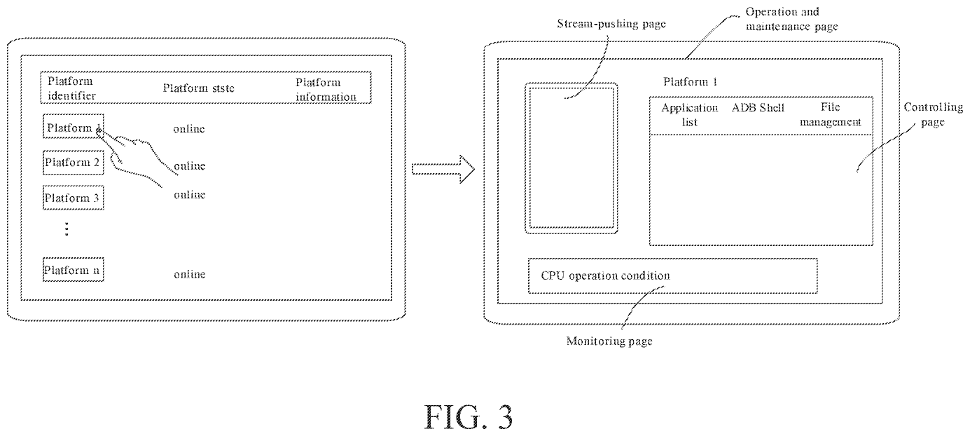

For the convenience of understanding, this technical solution will be described in detail with reference to FIG. 3, which is a schematic diagram of information display provided by an embodiment of the present disclosure. As shown in FIG. 3, a platform list is displayed on the interface of the terminal device, the platform list includes at least one platform corresponding to a platform identifier, i.e. platform 1, platform 2, platform 3 . . . . platform n in the figure, and the embodiment of the present disclosure is not specifically limited as to the type of platform identifier, which may, for example, be any one or more of an icon, a name, an identifier (abbreviated as ID) and other identifiers of the platform.

In some embodiments, other information can also be displayed on the interface of the terminal device, such as a corresponding status and detailed information of each platform, which will not be described here.

Further, when the user selects a platform identifier in the platform list, the operation and maintenance page of the platform is displayed in the interface of the terminal device. In practical application, there are various ways of selecting the platform identifier, for example, by clicking on the platform identifier for selection, by voice input of the platform identifier for selection or by text input of the platform identifier for selection, where the selection by clicking is shown in FIG. 3 as an example but is not limited thereto.

Taking the first platform as the platform 1 for example, after the user selects the platform 1 on the terminal device, the operation and maintenance page of the platform 1 will be displayed on the interface of the terminal device, where the operation and maintenance page may include at least one of a stream-pushing page, a controlling page and a monitoring page.

In some embodiments, the stream-pushing page is used to display stream-pushing data of the first platform, for example, the stream-pushing data can be audio data, video data, etc.; the controlling page is used to display service information of the first platform, for example, the service information can be an application list, a controlling portal (Android Debug Bridge (abbreviated as ADB) Shell in the figure) or a file management, etc.; the monitoring page is used to display operation information of the first platform, for example, information about the operation condition of a Central Processing Unit (abbreviated as CPU), a Graphics Processing Unit (abbreviated as GPU), and a memory, etc. (the CPU operation is taken as an example in the figure, but it is not limited to this).

The information display method provided by the present embodiment can display the operation and maintenance page of the first platform in the display page of the terminal device in real time, so that the operation and maintenance information of the first platform can be monitored in real time through the operation and maintenance page, further enhancing the application experience of users on the first platform.

In practical application, the stream-pushing page is the same as the interface of the user terminal, and when the user turns on a stream-pushing function, the stream-pushing data can be displayed on the stream-pushing page of the terminal device while the stream-pushing data is also displayed on the user terminal. Specifically, the second platform acquires the interface information of the user terminal in real time, and displays the interface of the user terminal in the stream-pushing page. When the user turns on the stream-pushing function, the first platform sends the stream-pushing data to the second platform and the user terminal synchronously, so that the stream-pushing data of the first platform is displayed on the user terminal and the stream-pushing page of the second platform synchronously.

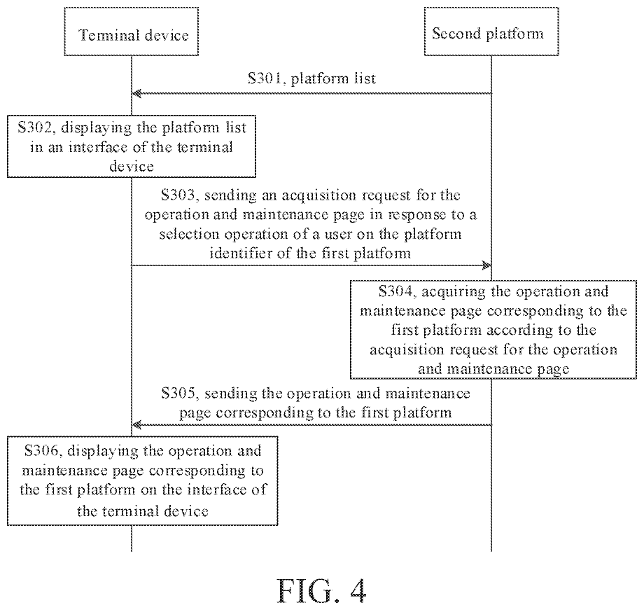

Next, with reference to FIG. 4, the solution of how to display the operation and maintenance page of the first platform on the interface of the terminal device through the second platform is described in detail.

FIG. 4 is a first signaling interaction diagram of an information display method provided by an embodiment of the present disclosure. As shown in FIG. 4, in the information display method provided by the embodiment of the present disclosure, the second platform and the terminal device perform the following steps.

S301: the second platform sends a platform list to a terminal device.

S302: the terminal device displays the platform list in an interface.

S303: the terminal device sends an acquisition request for the operation and maintenance page to a second platform in response to a selection operation of the user on the platform identifier of the first platform.

The operation and maintenance page request is used to obtain the operation and maintenance page of the first platform.

S304: the second platform acquires the operation and maintenance page corresponding to the first platform according to the acquisition request for the operation and maintenance page.

S305: the second platform sends the operation and maintenance page corresponding to the first platform to the terminal device.

S306: the terminal device displays the operation and maintenance page corresponding to the first platform on the interface.

The operation and maintenance page can include at least one of a stream-pushing page, a controlling page and a monitoring page.

Specifically, stream-pushing data is displayed in the stream-pushing page when the operation and maintenance page includes the stream-pushing page, where the stream-pushing data includes audio data and/or video data; service information of the first platform is displayed on the controlling page when the operation and maintenance page includes the controlling page, where the service information is, for example, an application list information, a controlling portal (ADB Shell in the figure) and a file management information; operation data of the first platform is displayed in the monitoring page when the operation and maintenance page includes the monitoring page, such as CPU operation condition, etc.

In the embodiment of the present disclosure, by displaying the service information and the operation and maintenance data of the first platform on the display page of the terminal device, the user can view the operation of the first platform in real time, thereby improving the user experience.

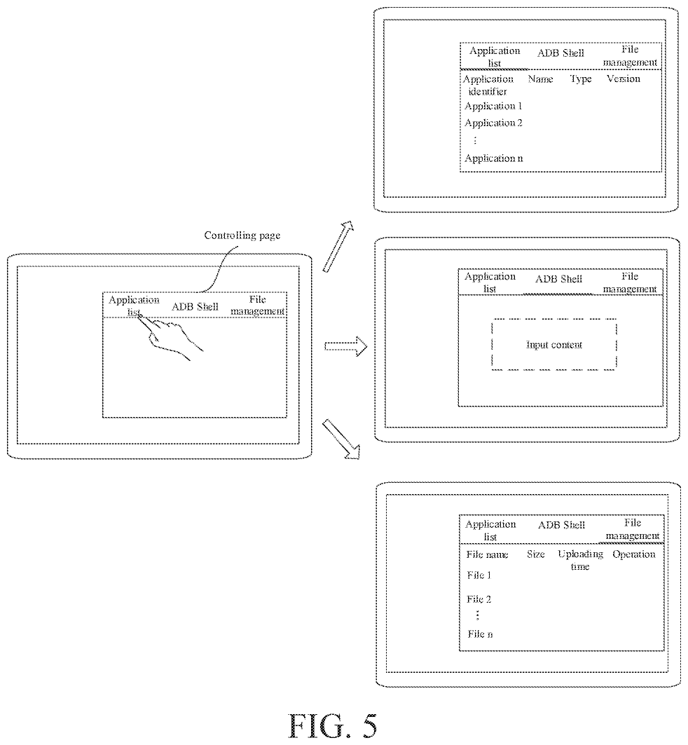

Taking the controlling page as an example, FIG. 5 is an information display schematic diagram of a controlling page provided by an embodiment of the present disclosure. As shown in FIG. 5, the controlling page can include multiple controlling components such as an application list, a control portal (ADB Shell in the figure) and a file management, and the user can view service information corresponding to the component by selecting any of the above components.

Specifically, when the user selects the component corresponding to the application list, related information of the application installed on the first platform is displayed in the controlling page, such as an application identifier (e.g., application icon, serial number, etc.), an application name, an application type (e.g., game application, office application, etc.), an application version, an application size, an application running condition, etc.

When the user selects the component corresponding to the ADB Shell, an input box is displayed in the controlling page for inputting a controlling instruction, so as to control the first platform through the controlling instruction.

When the user selects the component corresponding to file management, file information of the first platform is displayed in the controlling page, such as a file identifier (file name, file icon, etc.), a file type (local file, cloud file, etc.), a file size, a file uploading time and other operating components (for example, deleting, viewing details, etc.).

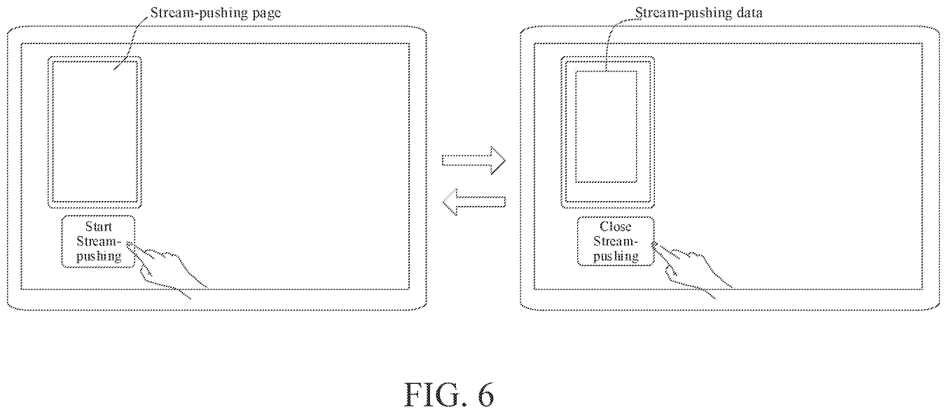

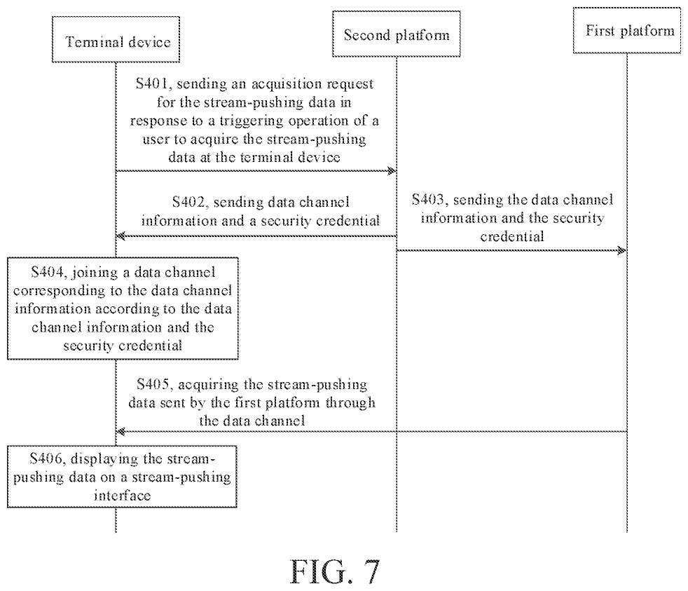

In some embodiments, when the stream-pushing page is included in the operation and maintenance page, the user can further acquire the stream-pushing data or close the stream-pushing data according to the requirements, the solution will be described in detail with reference to FIG. 6 and FIG. 7.

FIG. 6 is a first information display schematic diagram of a stream-pushing page provided by an embodiment of the present disclosure. As shown in FIG. 6, the operation and maintenance page of the first platform also includes a stream-pushing controlling component. When the stream-pushing stream data is not displayed in the stream-pushing stream page, the controlling component is used to start the stream-pushing, that is, when the user triggers the controlling component, the terminal device acquires the stream-pushing data and displays the stream-pushing data in the stream-pushing page.

Further, when the stream-pushing data is displayed in the stream-pushing page, the controlling component is used to close the stream-pushing, that is, when the user triggers the component, the stream-pushing page does not display the stream-pushing data.

For the convenience of understanding, the acquisition process of stream-pushing stream data will be described in detail in combination with the embodiment below, FIG. 7 is a second signaling interaction diagram of an information display method provided by an embodiment of the present disclosure. As shown in FIG. 7, in the information display method provided by the embodiment of the present disclosure, the second platform and the terminal device respectively perform the following steps.

S401: the terminal device sends an acquisition request for the stream-pushing data in response to a triggering operation of a user to acquire THE stream-pushing data at the terminal device.

S402: the second platform sends data channel information and a security credential to the terminal device.

S403: the second platform sends the data channel information and the security credential to the first platform.

S404: the terminal device joins a data channel corresponding to the data channel information according to the data channel information and the security credential.

Correspondingly, the first platform also joins the data channel corresponding to the data channel information according to the data channel information and the security credential, and then sends the stream-pushing data to the terminal device through the data channel.

It should be noted that for the terminal device and the first platform, the solution of joining the data channel according to the data channel information and the security credential can be referred to the existing solution and will not be described here.

S405: the terminal device acquires stream-pushing data sent by the first platform through the data channel.

S406: the terminal device displays the stream-pushing data on the stream-pushing page.

It should be understood that the stream-pushing data display solution of the terminal device is the same as that in the embodiment shown in FIG. 6, and will not be repeated here.

Through the embodiment of the present disclosure, the user can turn on or off the stream-pushing data according to the requirements, thereby meeting the personalized requirements of the user and improving the user experience.

In some embodiments, the operation and maintenance page further includes at least one controlling component, and the controlling component includes at least one of the following components: a page size adjustment component, a volume adjustment component, a page direction adjustment component, a notification bar controlling component, a stream-pushing data schedule adjustment component, a menu page controlling component, a screen recording component, a screen capture controlling component and a page switching component.

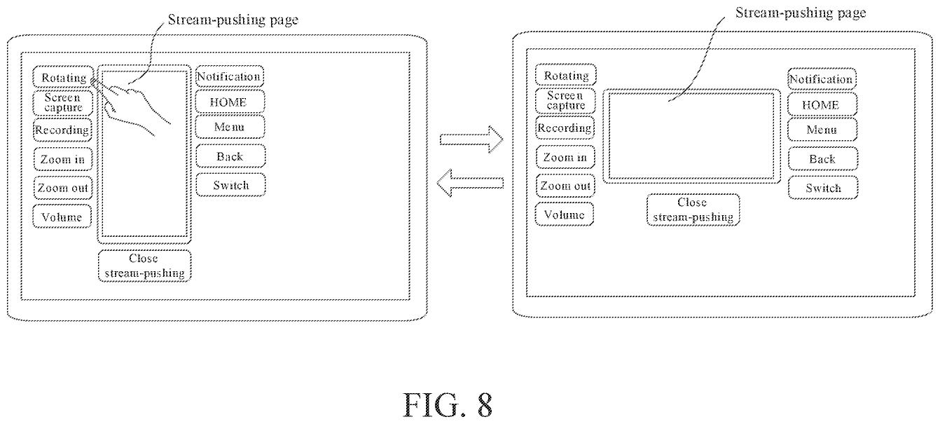

FIG. 8 is a second information display schematic diagram of a stream-pushing page provided by an embodiment of the present disclosure. As shown in FIG. 8, when the user triggers a rotating component, the stream-pushing page displayed in the interface of the terminal device is rotated. It should be noted that the embodiment of the present disclosure is not specifically limited with respect to the direction of rotation and the angle of rotation, for example, it may be set to rotate the stream-pushing page clockwise by 90° for each trigger of the rotation component.

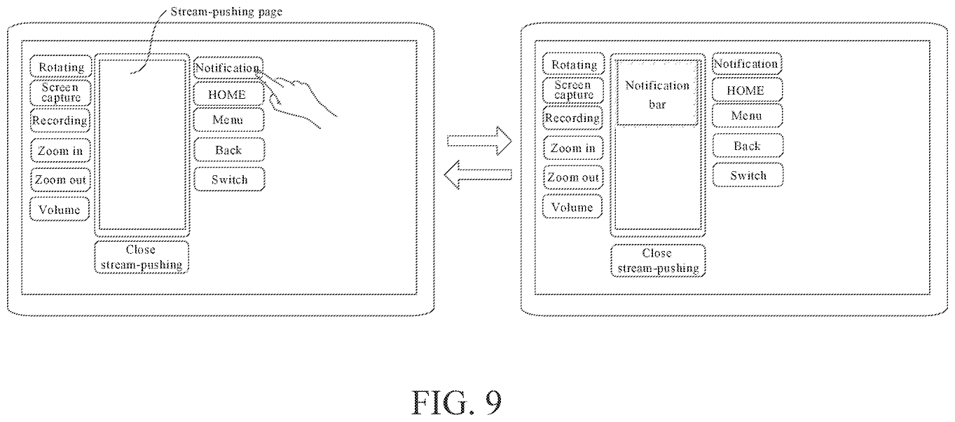

FIG. 9 is a third information display schematic diagram of a stream-pushing page provided by an embodiment of the present disclosure. As shown in FIG. 9, when the user triggers the notification bar controlling component, a notification bar is displayed in the stream-pushing page, so that a notification message of the first platform is displayed in the notification bar.

It should be noted that the display methods corresponding to other controlling components are the same as those of the above components, and they are not repeated here.

In addition, the arrangement of the controlling components shown in the above figure is exemplary, and is not a specific limitation to the present disclosure. In practical application, the controlling components can also be displayed in the operation and maintenance page of the first platform in other ways, for example, they are all arranged on any side of the stream-pushing page.

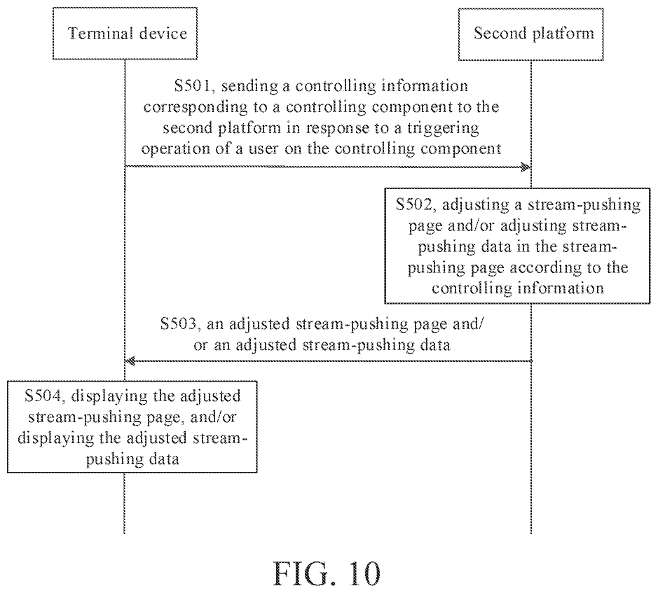

For the convenience of understanding, the adjustment process of the stream-pushing page or the stream-pushing data will be described in detail in combination with the embodiment below. FIG. 10 is a third signaling interaction diagram of an information display method provided by an embodiment of the present disclosure. As shown in FIG. 10, in the information display method provided by the embodiment of the present disclosure, when adjusting the stream-pushing page or the stream-pushing data, the second platform and the terminal device respectively perform the following steps.

S501: the terminal device sends controlling information corresponding to the controlling component to the second platform in response to the triggering operation of the user on the controlling component.

S502: the second platform adjusts the stream-pushing page and/or adjusts the stream-pushing data in the stream-pushing page according to the controlling information.

S503: the second platform sends an adjusted stream-pushing page and/or an adjusted stream-pushing data to the terminal device.

S504: the terminal device displays the adjusted stream-pushing page, and/or displays the adjusted stream-pushing data on the terminal device.

Through the solution provided by the embodiment of the present disclosure, the user can adjust the streaming data in real time through the second platform, so as to meet the personalized needs of the user and further improve the user experience.

In some embodiments, the terminal device can also configure the operation and maintenance page of the first platform through the second platform, which specifically includes that following steps.
1) Displaying a configuration page of the first platform on the terminal device, where the configuration page includes multiple configuration components.

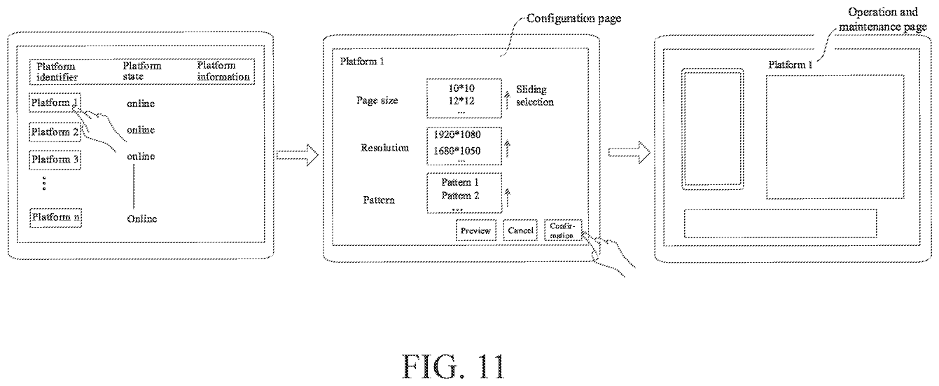

FIG. 11 is an information display schematic diagram of a configuration page provided by an embodiment of the present disclosure. As shown in FIG. 11, after the user selects the platform to be configured, the configuration page of the platform is displayed on the interface of the terminal device.

The configuration page includes multiple configuration components, such as a size configuration component of the operation and maintenance page, a resolution configuration component of the operation and maintenance page, and a pattern configuration component of the operation and maintenance page.
2) Configuring an operation and maintenance page to be configured according to a triggering operation of the user on the configuration components in response to the triggering operation.

It should be understood that the embodiment of the present disclosure does not specifically limit the way of triggering operation, for example, by a sliding operation in the up and down/left and right direction to select a desired parameter. In addition, the user can also fill in the corresponding parameters in the corresponding configuration area according to the requirements.
3) Determining that a current operation and maintenance page to be configured is the operation and maintenance page of the first platform in response to a configuration completion operation of the user.

Specifically, when the user completes the configuration and triggers a “confirmation” button, the corresponding operation and maintenance page is generated according to the currently set configuration parameters.

It should be noted that the configuration component can also include other types of components, such as a preview component, a cancel component, an undo component and so on. For example, after the user completes configuration of the parameters, the user can first trigger the “preview” component, thus generating an operation and maintenance page for the user to preview according to current configuration parameters; when the user triggers the cancel component, the user can return to a platform selection page, that is, the platform selection page is displayed in the interface of the terminal device.
4) Displaying the operation and maintenance page of the first platform on the interface of the terminal device.

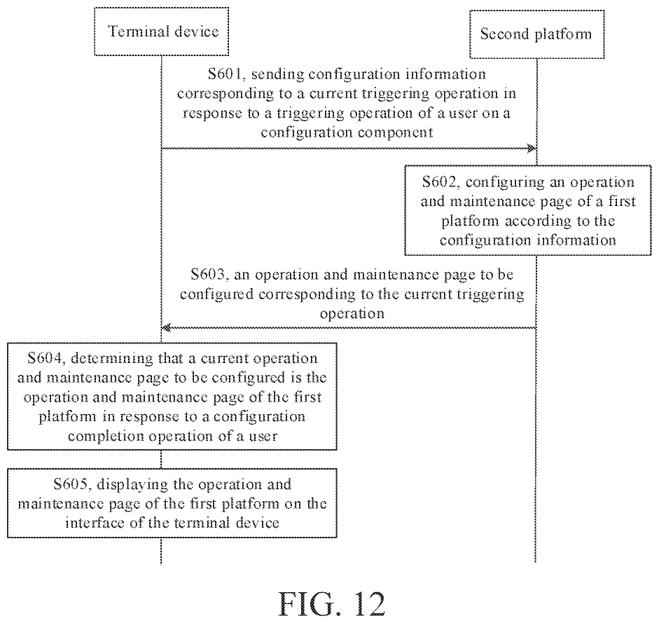

For the convenience of understanding, the process of configuring the operation and maintenance page of the first platform will be described in detail with specific examples. FIG. 12 is a fourth signaling interaction diagram of an information display method provided by an embodiment of the present disclosure. As shown in FIG. 12, in the information display method provided by the embodiment of the present disclosure, when configuring the operation and maintenance page of the first platform through the second platform, the second platform and the terminal device respectively perform the following steps respectively.

S601: the terminal device sends configuration information corresponding to the triggering operation to a second platform in response to the triggering operation of a user on the configuration components.

S602: the second platform configures the operation and maintenance page of the first platform according to the configuration information.

Specifically, the second platform sends the configuration information to the first platform, and the configuration information is used to instruct the first platform to configure the operation and maintenance page according to the configuration information.

Further, the second platform obtains the operation and maintenance page to be configured obtained by the first platform according to the current triggering operation, thereby realizing the configuration of the operation and maintenance page of the first platform.

S603: the second platform sends an operation and maintenance page to be configured corresponding to the current triggering operation to the terminal device.

S604: determining that a current operation and maintenance page to be configured is the operation and maintenance page of the first platform in response to a configuration completion operation of the user.

S605: the terminal device displays the operation and maintenance page of the first platform on the interface.

It should be noted that steps S604 to S605 are similar to the solution of the embodiment shown in FIG. 11, and the details can be referred to above, so they are not repeated here.

Through the embodiment of the present disclosure, the user can personalize the operation and maintenance page of the first platform through the second platform, thereby improving the user experience.

In some embodiments, the terminal device can also manage the application programs on the first platform, for example, installing an application program on the first platform or uninstalling an application program on the first platform, specifically including the following steps.
1) Displaying an application program management page on the interface of the terminal device in response to a triggering operation of the user for an application program management in the terminal device, and the application program management page includes an application installation page and an application uninstallation page.
2) Displaying an identifier corresponding to an application program to be processed in the operation and maintenance page or deleting the identifier corresponding to the application program to be processed in the operation and maintenance page in response to a controlling operation of the user on the application program to be processed.

The controlling operation includes: an installation operation or an uninstallation operation, and correspondingly, the application to be processed includes: an application to be installed and an application to be uninstalled.

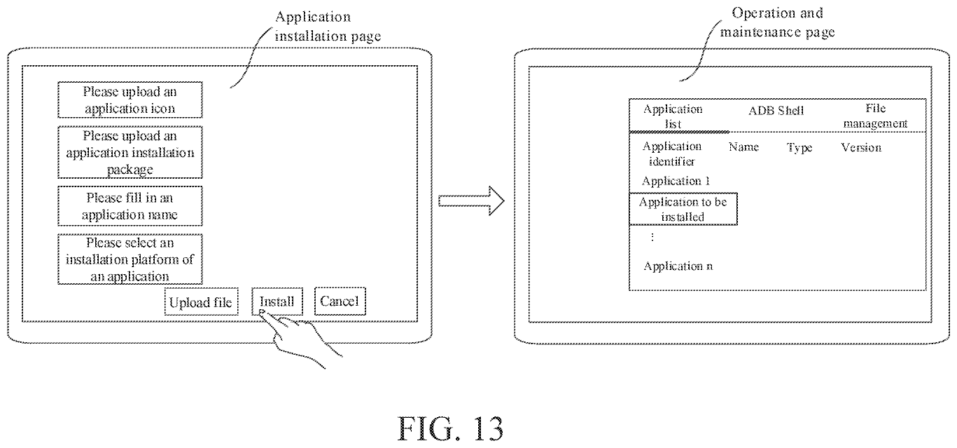

FIG. 13 is a first information display schematic diagram of an application program management page provided by an embodiment of the present disclosure. As shown in FIG. 13, when a user triggers an application installation operation, an application installation page as shown in FIG. 13 is displayed on the interface of the terminal device, which may include a file upload component, an application installation component, a cancellation component and other components.

In practical application, the user can upload files such as installation package and icon of the application to be installed by triggering an “Upload File” component, and fill in relevant information of the application to be installed, such as name, type, etc.

Further, a target platform for installing the application program to be installed is selected, and when the operation is completed, the component to be installed is installed on the target platform by triggering an “Install” component.

In an implementation, during the installation process, the user can trigger a “Cancel” component at any time to exit the application installation page.

Accordingly, after the installation is completed, the application program can also be displayed on the operation and maintenance page of the platform.

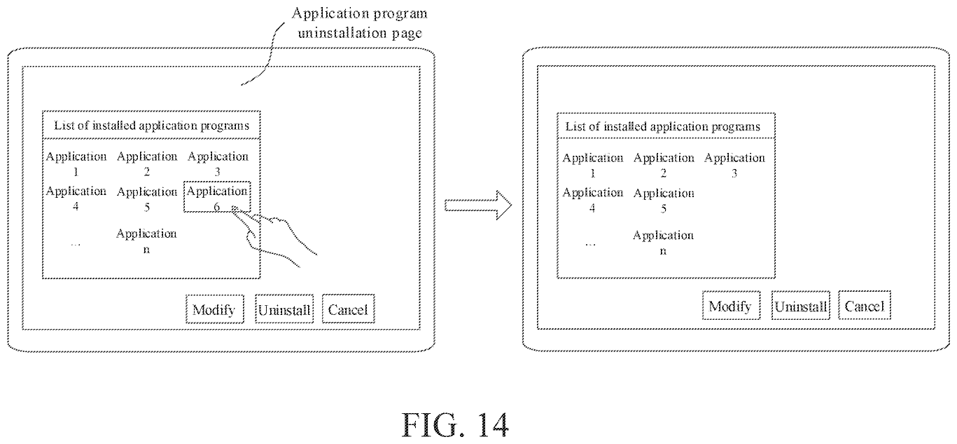

FIG. 14 is a second information display schematic diagram of an application program management page provided by an embodiment of the present disclosure. As shown in FIG. 14, when the user triggers an application program uninstallation operation of a certain platform, an application program uninstallation page as shown in FIG. 14 is displayed on the display interface of the terminal device, which includes: an identifier of the installed application program of the platform, and an uninstall component, a modify component, a cancel component, etc.

The user can select the identifier of the application program to be uninstalled, and then uninstall the application program by triggering an “uninstall” component. It should be noted that the mode of selecting the application programs to be uninstalled is not specifically limited in the embodiment of the present disclosure. For example, the application programs to be uninstalled can be selected one by one, or multiple application programs to be uninstalled can be selected in batches, so as to uninstall in batches.

Accordingly, after the uninstallation is completed, the identifier corresponding to the application program is deleted from the list of installed application programs.

In an implementation, during the uninstallation process, the user can trigger the “Cancel” component at any time to exit the application program uninstallation page.

In some embodiments, the installed application program can be modified by triggering the “Modify” component on this page, for example, the name, type, icon and other information of the application program can be modified, and the operation process and principle are similar to the above solution, so they are not described here.

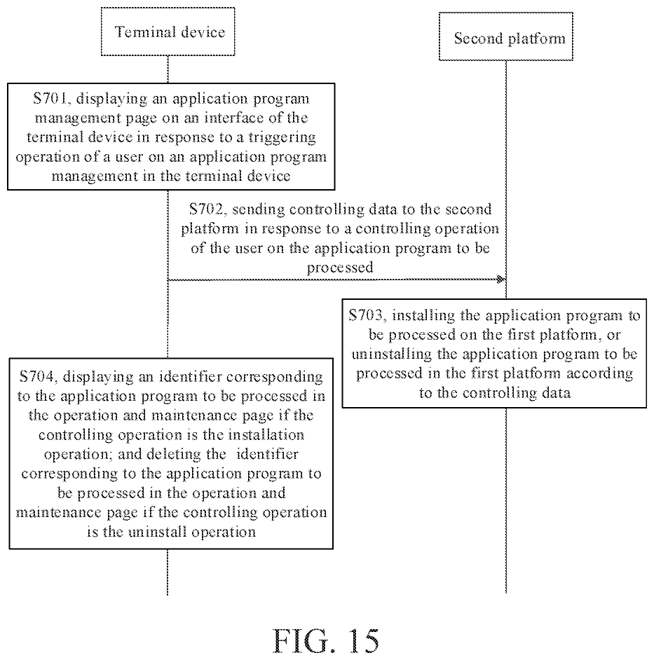

For the convenience of understanding, the application program management process will be described in detail with specific embodiments: FIG. 15 is a fifth signaling interaction diagram of an information display method provided by an embodiment of the present disclosure. As shown in FIG. 15, in the information display method provided by the embodiment of the present disclosure, when the application program of the first platform is managed by the second platform, the second platform and the terminal device respectively perform the following steps.

S701: displaying an application program management page on an interface of the terminal device in response to a triggering operation of a user on an application program management in the terminal device.

S702: sending controlling data to the second platform in response to a controlling operation of the user on the application program to be processed.

S703: installing the application program to be processed on the first platform, or uninstalling the application program to be processed in the first platform according to the controlling data.

S704: displaying an identifier corresponding to the application program to be processed in the operation and maintenance page if the controlling operation is the installation operation, and deleting the identifier corresponding to the application program to be processed in the operation and maintenance page if the controlling operation is the uninstall operation.

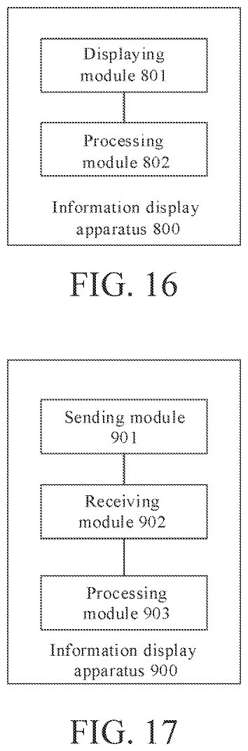

Corresponding to the information display method shown in the above embodiment, FIG. 16 is a first schematic diagram of an information display apparatus provided by an embodiment of the present disclosure. For convenience of explanation, only those portions relating to embodiment of the present disclosure are shown. As shown in FIG. 16, the information display apparatus 800 includes:
a displaying module 801, which displays a platform list in an interface of a terminal device, where the platform list includes a platform identifier corresponding to at least one platform; and
a processing module 802, configured to control the displaying module to display an operation and maintenance page of a first platform on the interface of the terminal device in response to a selection operation of a user on the platform identifier of the first platform, where the operation and maintenance page includes at least one of a stream-pushing page, a controlling page and a monitoring page.

In one embodiment of the present disclosure, the processing module 802 is specifically configured to: send an acquisition request for the operation and maintenance page of the first platform to a second platform in response to the selection operation of the user on the platform identifier of the first platform; acquire a configuration data sent by the second platform according to the acquisition request for the operation and maintenance page; and display the operation and maintenance page of the first platform on the interface of the terminal device according to the configuration data.

In one embodiment of the present disclosure, the display module 801 is further configured to: display stream-pushing data in the stream-pushing page when the operation and maintenance page includes the stream-pushing page, where the stream-pushing data includes audio data and/or video data;
display service information of the first platform on the controlling page when the operation and maintenance page includes the controlling page, where the service information includes at least one of an application list, a controlling portal and file information; and display operation data of the first platform in the monitoring page when the operation and maintenance page includes the monitoring page. In one embodiment of the present disclosure, the display module 801 is specifically configured to display the stream-pushing data on the stream-pushing page in response to a triggering operation of the user to acquire the stream-pushing data at the terminal device.

In one embodiment of the present disclosure, the display module 801 is specifically configured to: send an acquisition request for the stream-pushing data to a second platform in response to the triggering operation of the user to acquire the stream-pushing data at the terminal device; acquire data channel information and a security credential sent by the second platform according to the acquisition request for the stream-pushing data; join a data channel corresponding to the data channel information according to the data channel information and the security credential; and acquire stream-pushing data sent by the first platform through the data channel, and display the stream-pushing data on the stream-pushing page.

In one embodiment of the present disclosure, the operation and maintenance page further includes at least one controlling component, and the controlling component includes at least one of the following components: a page size adjustment component, a volume adjustment component, a page direction adjustment component, a notification bar controlling component, a stream-pushing data schedule adjustment component, a menu page controlling component, a screen recording component, a screen capture controlling component and a page switching component;
the processing module 802 is further configured to adjust the stream-pushing page according to a triggering operation of the user on the controlling component or adjusting stream-pushing data in the stream-pushing page according to the triggering operation in response to the triggering operation.

In one embodiment of the present disclosure, the processing module 802 is specifically configured to: send controlling information corresponding to the controlling component to a second platform in response to the triggering operation of the user on the controlling component, where the controlling information is used to instruct to adjust the stream-pushing page on the second platform and/or instruct to adjust the stream-pushing data in the stream-pushing page on the second platform; and display an adjusted stream-pushing page on the terminal device, and/or display an adjusted stream-pushing data on the terminal device.

In an embodiment of the present disclosure, the display module 801 is further configured to: display a configuration page of the first platform on the terminal device, where the configuration page includes multiple configuration components, and the configuration components include at least one of the following: a size of the operation and maintenance page, a resolution of the operation and maintenance page and a pattern of the operation and maintenance page; configure an operation and maintenance page to be configured according to a triggering operation of the user on the configuration components in response to the triggering operation; determine that a current operation and maintenance page to be configured is the operation and maintenance page of the first platform in response to a configuration completion operation of the user; and display the operation and maintenance page of the first platform on the interface of the terminal device.

In one embodiment of the present disclosure, the processing module 802 is further configured to: send configuration information corresponding to the triggering operation to a second platform in response to the triggering operation of the user on the configuration components, where the configuration information is used to instruct the first platform to configure the operation and maintenance page; and receive an operation and maintenance page to be configured corresponding to a current triggering operation.

In one embodiment of the present disclosure, the processing module 802 is further configured to: display an application program management page on the interface of the terminal device in response to a triggering operation of the user for an application program management in the terminal device; and display an identifier corresponding to an application program to be processed in the operation and maintenance page or delete the identifier corresponding to the application program to be processed in the operation and maintenance page in response to a controlling operation of the user on the application program to be processed; where the controlling operation includes an installation operation or an uninstallation operation.

In one embodiment of the present disclosure, the processing module 802 is further configured to: send controlling data to a second platform in response to the controlling operation of the user on the application program to be processed, where the controlling data is used to instruct to install the application program to be processed in the first platform or to instruct to uninstall the application program to be processed in the first platform; display an identifier corresponding to the application program to be processed in the operation and maintenance page if the controlling operation is the installation operation; and delete the identifier corresponding to the application program to be processed in the operation and maintenance page if the controlling operation is the uninstall operation

The information display apparatus provided in the present embodiment can be used to execute the technical solutions in the foregoing method embodiments; implementation principles and technical effects therebetween are similar, and details will not be described herein again in the present embodiment.

Corresponding to the information display method shown in the above embodiment, FIG. 17 is a second schematic diagram of an information display apparatus provided by an embodiment of the present disclosure. For convenience of explanation, only those portions relating to embodiments of the present disclosure are shown. As shown in FIG. 17, the information display apparatus 900 includes:

a sending module 901, configured to send a platform list to a terminal device, where the platform list includes a platform identifier corresponding to at least one platform; a receiving module 902, configured to receive an acquisition request for an operation and maintenance page of a first platform sent by the terminal device; and a processing module 903, configured to acquire the operation and maintenance page corresponding to the first platform according to the acquisition request for the operation and maintenance page, and send the operation and maintenance page corresponding to the first platform to the terminal device through the sending module 901, where the operation and maintenance page includes at least one of a stream-pushing page, a controlling page and a monitoring page.

In one embodiment of the present disclosure, the sending module 901 is specifically configured to acquire configuration data of the first platform according to the acquisition request for the operation and maintenance page; and send the configuration data to the terminal device, where the configuration data is used for displaying the operation and maintenance page of the first platform on an interface of the terminal device.

In an embodiment of the present disclosure, the receiving module 902 is further configured to: acquire an acquisition request for stream-pushing data sent by the terminal device;
the sending module 901 is further configured to: send a data channel information and a security credential to the terminal device and the first platform according to the acquisition request for the stream-pushing data; where the data channel information and the security credential are used for the terminal device and the first platform to enter a data channel corresponding to the data channel information, and the data channel is used for the terminal device to acquire stream-pushing data sent by the first platform, and the stream-pushing data includes at least one of the following: an audio data and/or a video data.

In an embodiment of the present disclosure, the sending module 901 is further configured to: send a configuration page of the first platform to the terminal device, where the configuration page includes multiple configuration components, and the configuration components include at least one of the following: a size of the operation and maintenance page, a resolution of the operation and maintenance page and a pattern of the operation and maintenance page;
the receiving module 902 is further configured to: receive configuration information corresponding to a current triggering operation sent by the terminal device; the sending module 901 is further configured to send the configuration information to the first platform, where the configuration information is used to instruct the first platform to configure the operation and maintenance page according to the configuration information.

In one embodiment of the present disclosure, the receiving module 902 is further configured to: receive controlling information corresponding to a triggering operation for an application program management sent by the terminal device; the sending module 901 is further configured to send an application program management page to the terminal device, where the application program management page is used for the terminal device to manage an application program to be processed; the receiving module 902 is further configured to: receive controlling data corresponding to a controlling operation sent by the terminal device; the processing module 903 is further configured to: install the application program to be processed in the first platform or uninstall the application program to be processed in the first platform according to the controlling data.

The information display apparatus provided in the present embodiment can be used to execute the technical solutions in the foregoing method embodiments; implementation principles and technical effects therebetween are similar, and details will not be described herein again in the present embodiment.

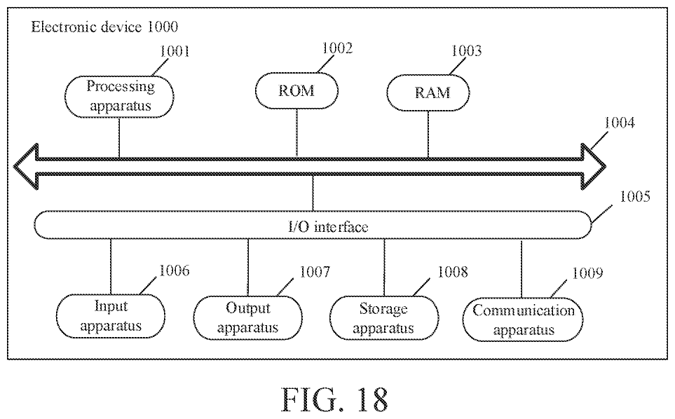

FIG. 18 is a schematic diagram of an electronic device provided by an embodiment of the present disclosure. It shows a schematic structural diagram of an electronic device 1000 suitable for implementing the embodiment of the present disclosure, the electronic device 1000 may be a terminal device or the above-mentioned second platform, where the terminal device may include, but is not limited to, a mobile terminal such as a mobile phone, a notebook computer, a digital broadcast receiver, a personal digital assistant (abbreviated as PDA), a portable android device (abbreviated as PAD), a portable media player (abbreviated as PMP), a vehicle-mounted terminal (such as vehicle-mounted navigation terminal) or the like, and a fixed terminal such as a digital TV, a desktop computer or the like.

It should be understood that the electronic device shown in FIG. 18 is merely an example, which should not impose any restrictions on functionalities and application program scope of the embodiments of the present disclosure.

As shown in FIG. 18, an electronic device 1000 may include a processing apparatus (such as a central processing unit, a graphics processor, etc.) 1001, which may perform various appropriate actions and processes according to a program stored in a read only memory (abbreviated as ROM) 1002 or a program loaded into a random access memory (abbreviated as RAM) 1003 from a storage apparatus 1008. In the RAM 1003, various programs and data required for operations of the electronic device 1000 are also stored. The processing apparatus 1001, the ROM 1002 and the RAM 1003 are connected to each other through a bus 1004. An input/output (abbreviated as I/O) interface 1005 is also connected to the bus 1004.

Generally, the following apparatuses may be connected to the I/O interface 1005: an input apparatus 1006, including, for example, a touch screen, a touch pad, a keyboard, a mouse, a camera, a microphone, an accelerometer, a gyroscope or the like; an output apparatus 1007, including, for example, a liquid crystal display (abbreviated as LCD), a speaker, a vibrator or the like; a storage apparatus 1008, including, for example, a magnetic tape, a hard disk or the like; and a communication apparatus 10010. The communication apparatus 10010 may allow the electronic device 1000 to communicate wirelessly or wiredly with a further device for data exchange. Although FIG. 18 shows an electronic device 1000 with various apparatuses, comprehensibly, there is no such requirement that all the apparatuses shown should be implemented or provided. Alternatively, more or fewer apparatuses may be implemented or provided.

Particularly, according to the embodiments of the present disclosure, the processes described above with reference to the flowcharts can be implemented as a computer software program. For example, an embodiment of the present disclosure includes a computer program product including a computer program carried on a computer-readable medium, where the computer program contains program codes for executing the method shown in the flowcharts. In such an embodiment, the computer program can be downloaded and installed from the network through the communication apparatus 10010, or installed from the storage apparatus 1008 or from the ROM 1002. When executed by the processing apparatus 1001, the computer program performs the above-described functionalities defined in the method according to the embodiments of the present disclosure.

It should be noted that the above-described computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared or semi-conductive system, apparatus or device, or any combination of the above. More specific examples of the computer-readable storage medium may include, but not limited to, an electrically connected portable computer disk with one or more wires, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium in which a program is contained or stored. The program can be used by or in combination with an instruction execution system, apparatus or device. In the present disclosure, the computer-readable signal medium may include a data signal propagated in a baseband or as a part of a carrier wave, where computer-readable program codes are carried. This propagated data signal may be in various forms, including but not limited to electromagnetic signals, optical signals or any suitable combination of the above. The computer-readable signal medium may also be any computer-readable medium other than the computer-readable storage medium. The computer-readable signal medium can send, propagate or transmit the program used by or in combination with the instruction execution system, apparatus or device. The program codes contained in the computer-readable medium can be transmitted using any suitable medium, including but not limited to: electric wires, optical cables, radio frequency (abbreviated as RF), etc., or any suitable combination of the above.

The computer-readable medium may be included in the above-described electronic device; or it may exist alone without being assembled into the electronic device.

The above-described computer-readable medium carries one or more programs which, when executed by the electronic device, enable the electronic device to execute the method shown in the above-described embodiments.

Computer program codes for performing the operations of the present disclosure can be written in one or more programming languages or a combination thereof. The above-described programming languages include object-oriented programming languages such as Java, Smalltalk and C++, and conventional procedural programming languages such as “C” language or similar programming languages. The program codes can be completely executed on a user computer, partially executed on a user computer, executed as an independent software package, partially executed on a user computer and partially executed on a remote computer, or completely executed on a remote computer or a server. In a case related to the remote computer, the remote computer can be connected to a user computer through any kind of networks, including a local area network (abbreviated as LAN) or a wide area network (abbreviated as WAN), or can be connected to an external computer (for example, being connected over Internet with use of an Internet service provider).

The flowcharts and block diagrams in the drawings illustrate architectures, functionalities and operations of possible implementations of the system, the method and the computer program product according to various embodiments of the present disclosure. In this regard, each block in the flowcharts or block diagrams may represent a module, a program segment or part of codes, which contains one or more executable instructions for implementing specified logical functionalities. It should also be noted that, in some alternative implementations, the functionalities marked in the blocks may also occur in an order different from that marked in the drawings. For example, two blocks shown in succession can actually be executed in a substantially parallel manner, and sometimes they can be executed in a reverse order, depending on the functionalities involved. It should also be noted that each block in the block diagrams and/or the flowcharts, and a combination of blocks in the block diagrams and/or the flowcharts, may be implemented by a dedicated hardware-based system that performs specified functionalities or operations, or may be implemented by a combination of dedicated hardware and computer instructions.

The units involved in the embodiments described in the present disclosure may be implemented by means of software or hardware. In some cases, unit names do not limit the units intrinsically. For example, a first acquiring unit can also be described as “a unit acquiring at least two Internet protocol addresses”.

The functionalities described above herein can be at least partially performed by one or more hardware logic components. For example, non-restrictively, the hardware logic components that can be used include the following exemplary types: a field programmable gate array (abbreviated as FPGA), an application specific integrated circuit (abbreviated as ASIC), an application specific standard product (abbreviated as ASSP), a system on chip (abbreviated as SOC), a complex programmable logic device (abbreviated as CPLD) and the like.

In the context of the present disclosure, a machine-readable medium can be a tangible medium in which a program used by or in combination with an instruction execution system, apparatus or device can be contained or stored. The machine-readable medium can be a machine-readable signal medium or a machine-readable storage medium. The machine-readable medium may include, but not limited to, an electronic, magnetic, optical, electromagnetic, infrared, or semiconductor system, apparatus or device, or any suitable combination of the foregoing. More specific examples of the machine-readable storage medium may include an electrically connected, portable computer disk based on one or more wires, a hard disk, a RAM, a ROM, an EPROM or flash memory, an optical fiber, a CD-ROM, an optical storage device, a magnetic storage device, or any suitable combination of the foregoing.

The above descriptions are only preferred embodiments of the present disclosure and illustrations of the applied technical principles. Those skilled in the art should understand that the disclosure scope involved in the present disclosure is not limited to the technical solution formed from a specific combination of the above-described technical features, but covers other technical solutions formed from any combination of the above-described technical features or their equivalent features without departing from the above disclosed concept, such as a technical solution formed from replacement of the above-described features with technical features having similar functionalities to those disclosed in (but not limited to) the present disclosure.

Furthermore, although the operations are depicted in a particular order, this does not mean a requirement that these operations should be performed in the particular order shown or in a sequential order. Under certain circumstances, multitasking and parallel processing may be beneficial. Similarly, although the above discussion contains several specific implementation details, these should not be interpreted as limitations on the scope of the present disclosure. Some features described in the context of separate embodiments also may be implemented in a single embodiment in combination. On the contrary, various features described in the context of a single embodiment also may be implemented in multiple embodiments separately or in any suitable sub-combinations.

Although the subject matter has been described in language specific to structural features and/or methodological logical actions, it will be appreciated that the subject matter defined in the appended claims is not necessarily limited to the specific features or actions described above. On the contrary, the specific features and actions described above are only exemplary forms for implementing the claims.

What is claimed is:

1. An information display method, comprising:
displaying a platform list in an interface of a terminal device, wherein the platform list comprises a platform identifier corresponding to at least one platform; and
displaying an operation and maintenance page of a first platform on the interface of the terminal device in response to a selection operation of a user on the platform identifier of the first platform, wherein the operation and maintenance page comprises at least one of a stream-pushing page, a controlling page and a monitoring page.

2. The information display method according to claim 1, wherein the displaying the operation and maintenance page of the first platform on the interface of the terminal device in response to the selection operation of the user on the platform identifier of the first platform, comprises:
sending an acquisition request for the operation and maintenance page of the first platform to a second platform in response to the selection operation of the user on the platform identifier of the first platform;
acquiring a configuration data sent by the second platform according to the acquisition request for the operation and maintenance page; and
displaying the operation and maintenance page of the first platform on the interface of the terminal device according to the configuration data.

3. The information display method according to claim 1, further comprising:
displaying stream-pushing data in the stream-pushing page when the operation and maintenance page comprises the stream-pushing page, wherein the stream-pushing data comprises audio data and/or video data;
displaying service information of the first platform on the controlling page when the operation and maintenance page comprises the controlling page, wherein the service information comprises at least one of an application list, a controlling portal and file management; and
displaying operation data of the first platform in the monitoring page when the operation and maintenance page comprises the monitoring page.

4. The information display method according to claim 3, wherein the displaying the stream-pushing data in the stream-pushing page when the operation and maintenance page comprises the stream-pushing page, comprises:
displaying the stream-pushing data on the stream-pushing page in response to a triggering operation of the user to acquire the stream-pushing data at the terminal device.

5. The information display method according to claim 4, wherein the displaying the stream-pushing data on the stream-pushing page in response to the triggering operation of the user to acquire the stream-pushing data at the terminal device, comprises:
sending an acquisition request for the stream-pushing data to a second platform in response to the triggering operation of the user to acquire the stream-pushing data at the terminal device;
acquiring data channel information and a security credential sent by the second platform according to the acquisition request for the stream-pushing data;
joining a data channel corresponding to the data channel information according to the data channel information and the security credential; and
acquiring stream-pushing data sent by the first platform through the data channel, and displaying the stream-pushing data on the stream-pushing page.

6. The information display method according to claim 1, wherein the operation and maintenance page further comprises at least one controlling component, and the controlling component comprises at least one of the following components: a page size adjustment component, a volume adjustment component, a page direction adjustment component, a notification bar controlling component, a stream-pushing data schedule adjustment component, a menu page controlling component, a screen recording component, a screen capture controlling component and a page switching component;
wherein the information display method further comprises:
adjusting the stream-pushing page according to a triggering operation of the user on the controlling component or adjusting stream-pushing data in the stream-pushing page according to the triggering operation in response to the triggering operation.

7. The information display method according to claim 6, wherein the adjusting the stream-pushing page according to the triggering operation of the user on the controlling component or adjusting the stream-pushing data in the stream-pushing page according to the triggering operation in response to the triggering operation, comprises:
sending controlling information corresponding to the controlling component to a second platform in response to the triggering operation of the user on the controlling component, wherein the controlling information is used to instruct to adjust the stream-pushing page on the second platform and/or instruct to adjust the stream-pushing data in the stream-pushing page on the second platform; and
displaying an adjusted stream-pushing page on the terminal device, and/or displaying an adjusted stream-pushing data on the terminal device.

8. The information display method according to claim 1, further comprising:
displaying a configuration page of the first platform on the terminal device, wherein the configuration page comprises multiple configuration components, and the configuration components comprise at least one of the following: a size of the operation and maintenance page, a resolution of the operation and maintenance page and a pattern of the operation and maintenance page;
configuring an operation and maintenance page to be configured according to a triggering operation of the user on the configuration components in response to the triggering operation;
determining that a current operation and maintenance page to be configured is the operation and maintenance page of the first platform in response to a configuration completion operation of the user; and
displaying the operation and maintenance page of the first platform on the interface of the terminal device.

9. The information display method according to claim 8, wherein the configuring the operation and maintenance page to be configured according to the triggering operation of the user on the configuration components in response to the triggering operation, comprises:
sending configuration information corresponding to the triggering operation to a second platform in response to the triggering operation of the user on the configuration components, wherein the configuration information is used to instruct the first platform to configure the operation and maintenance page; and
receiving an operation and maintenance page to be configured corresponding to a current triggering operation.

10. The information display method according to claim 1, further comprising:
displaying an application program management page on the interface of the terminal device in response to a triggering operation of the user for an application program management in the terminal device; and
displaying an identifier corresponding to an application program to be processed in the operation and maintenance page or deleting the identifier corresponding to the application program to be processed in the operation and maintenance page in response to a controlling operation of the user on the application program to be processed;
wherein the controlling operation comprises an installation operation or an uninstallation operation.

11. The information display method according to claim 10, wherein the displaying the identifier corresponding to the application program to be processed in the operation and maintenance page or deleting the identifier corresponding to the application program to be processed in the operation and maintenance page in response to the controlling operation of the user on the application program to be processed, comprises:
sending controlling data to a second platform in response to the controlling operation of the user on the application program to be processed, wherein the controlling data is used to instruct to install the application program to be processed in the first platform or to instruct to uninstall the application program to be processed in the first platform;
displaying an identifier corresponding to the application program to be processed in the operation and maintenance page if the controlling operation is the installation operation; and
deleting the identifier corresponding to the application program to be processed in the operation and maintenance page if the controlling operation is the uninstall operation.

12. An information display method, comprising:
sending a platform list to a terminal device, wherein the platform list comprises a platform identifier corresponding to at least one platform;
receiving an acquisition request for an operation and maintenance page of a first platform sent by the terminal device; and
acquiring the operation and maintenance page corresponding to the first platform according to the acquisition request for the operation and maintenance page, and sending the operation and maintenance page corresponding to the first platform to the terminal device, wherein the operation and maintenance page comprises at least one of a stream-pushing page, a controlling page and a monitoring page.

13. The information display method according to claim 12, wherein the sending the operation and maintenance page corresponding to the first platform to the terminal device according to the acquisition request for the operation and maintenance page, comprises:
acquiring configuration data of the first platform according to the acquisition request for the operation and maintenance page; and
sending the configuration data to the terminal device, wherein the configuration data is used for displaying the operation and maintenance page of the first platform on an interface of the terminal device.

14. The information display method according to claim 12, further comprising:
acquiring an acquisition request for stream-pushing data sent by the terminal device; and
sending a data channel information and a security credential to the terminal device and the first platform according to the acquisition request for the stream-pushing data;
wherein the data channel information and the security credential are used for the terminal device and the first platform to enter a data channel corresponding to the data channel information, and the data channel is used for the terminal device to acquire stream-pushing data sent by the first platform, and the stream-pushing data comprises at least one of the following: an audio data and/or a video data.

15. The information display method according to claim 12, before the sending the platform list to the terminal device, further comprising:
sending a configuration page of the first platform to the terminal device, wherein the configuration page comprises multiple configuration components, and the configuration components comprise at least one of the following: a size of the operation and maintenance page, a resolution of the operation and maintenance page and a pattern of the operation and maintenance page;
receiving configuration information corresponding to a current triggering operation sent by the terminal device; and
sending the configuration information to the first platform, wherein the configuration information is used to instruct the first platform to configure the operation and maintenance page according to the configuration information.

16. The information display method according to claim 12, further comprising:
receiving controlling information corresponding to a triggering operation for an application program management sent by the terminal device;
sending an application program management page to the terminal device, wherein the application program management page is used for the terminal device to manage an application program to be processed;
receiving controlling data corresponding to a controlling operation sent by the terminal device; and
installing the application program to be processed in the first platform or uninstalling the application program to be processed in the first platform according to the controlling data.

17. An information display apparatus, comprising:
at least one processor and memory;
wherein the memory has a computer-executable instruction stored therein; and
the at least one processor executes the computer-executed instruction stored in the memory to enable the at least one processor to:
display a platform list in an interface of a terminal device, wherein the platform list comprises a platform identifier corresponding to at least one platform; and
display an operation and maintenance page of a first platform on the interface of the terminal device in response to a selection operation of a user on the platform identifier of the first platform, wherein the operation and maintenance page comprises at least one of a stream-pushing page, a controlling page and a monitoring page.

18. An information display apparatus, comprising:
at least one processor and memory;
wherein the memory has a computer-executable instruction stored therein; and
the at least one processor executes the computer-executed instruction stored in the memory to enable the at least one processor to perform the information display method according to claim 12.

19. (canceled)

20. A non-transitory computer-readable storage medium in which a computer-executable instruction is stored, wherein when the computer-executable instruction is executed by a processor, the information display method according to claim 1.

21-22. (canceled)

23. The information display apparatus according to claim 17, wherein the at least one processor executes the computer-executed instruction stored in the memory to enable the at least one processor to:
send an acquisition request for the operation and maintenance page of the first platform to a second platform in response to the selection operation of the user on the platform identifier of the first platform;
acquire a configuration data sent by the second platform according to the acquisition request for the operation and maintenance page; and
display the operation and maintenance page of the first platform on the interface of the terminal device according to the configuration data.
